(19) United States
(12) Patent Application Publication
(10) Pub. No.: US 2009/0063287 A1
(43) Pub. Date: Mar. 5, 2009

(54) Method of Processing Orders

(75) Inventors: Torre Tribout, Belleville, IL (US); Scott Geiler, Belleville, IL (US)

Correspondence Address: Welsh & Katz, 22nd Flr., 1120 S. Riverside Plaza, Chicago, IL, 60606, US

(73) Assignee: Sniperdyne, Belleville, IL (US)

(21) Appl. No.: 11/848,321

(22) Filed: Aug. 31, 2007

(51) Int. Cl. G06Q 30/00

(52) U.S. Cl. 705/26

(57) ABSTRACT

A method and apparatus are provided for processing orders by a host of an ordering organization, the orders being placed by the ordering organization with a vendor. The method includes the steps of an agent of the ordering organization accessing an order website and entering a plurality of order items and the host incorporating the order items and a change subroutine into a webpage. The method further includes the steps of an agent of the vendor retrieving the webpage from the host of the ordering organization, the agent of the ordering organization and agent of the vendor negotiating the conditions of the order and the change subroutine tracking and recording the agreed upon conditions.

### FIELD OF THE INVENTION

The field of the invention relates to purchases by organizations and, more particularly, to the tracking of purchases.

### BACKGROUND OF THE INVENTION

Methods used by organizations for purchases are well known. Typically, a purchasing agent, by reference to a catalog or by calling a representative of a vendor, will determine a cost and availability of an item. If the terms are acceptable, then the purchasing agent will issue a purchase order.

In some organizations, the verbal transmission of a purchase order from the purchasing agent to the vendor is understood to establish a purchasing contract without the requirement of any further writing. In other organizations, receipt of a written document by the vendor containing the purchase order and acceptance of the purchase order by the vendor is required before a contact will be found to exist. In these cases, the written document includes a precise description of the terms of the purchase. The terms may include an identifier of the purchased item, a quantity and a price. The terms may also specify a delivery date and a basis for any additional costs (e.g., freight). The terms may also include an identifier of a quality requirement. In the case where purchased items are fungible (i.e., a manufactured item), the identifier of the quality requirement may be satisfied if a part number of the delivered part is identical to the ordered part. In other cases, a parameter of the delivered part (e.g., taste, order, quality) may be measured and compared with a standard before delivery will be accepted.

While existing methods work relatively well, they are still subject to problems. In some cases, a vendor or purchasing agent may misunderstand the order, the supplied part or some condition of acceptance. In a busy business environment, the buyer or seller may request changes or accommodations and forget to write down the content or scope of the changes. In either case, the buyer will be disappointed in not receiving what the buyer thought that he/she had ordered. In either case, the mismatch of expectations may lead to litigation and missed dates. Accordingly, a need exists for better ways of processing purchasing information.

### SUMMARY

A method and apparatus are provided for processing orders by a host of an ordering organization, the orders being placed by the ordering organization with a vendor. The method includes the steps of an agent of the ordering organization accessing an order website and entering a plurality of order items and the host incorporating the order items and a change subroutine into a webpage. The method further includes the steps of an agent of the vendor retrieving the webpage from the host of the ordering organization, the agent of the ordering organization and agent of the vendor negotiating the conditions of the order and the change subroutine tracking and recording the agreed upon conditions.

### BRIEF DESCRIPTION OF THE DRAWINGS

FIG. 1 is a block diagram for tracking negotiations between a customer and buyer in accordance with an illustrated embodiment of the invention;

FIG. 2 is a screen shot of a purchase order webpage that may be used by the system of FIG. 1 for receiving changes from the vendor;

FIG. 3 is a screen shot of a webpage that may be used by the system of FIG. 1 for accepting changes to a purchase order;

FIG. 4 is a screen shot of a webpage that may be used by the system of FIG. 1 for receiving changes to the purchase order from the customer.

### DETAILED DESCRIPTION OF AN ILLUSTRATED EMBODIMENT

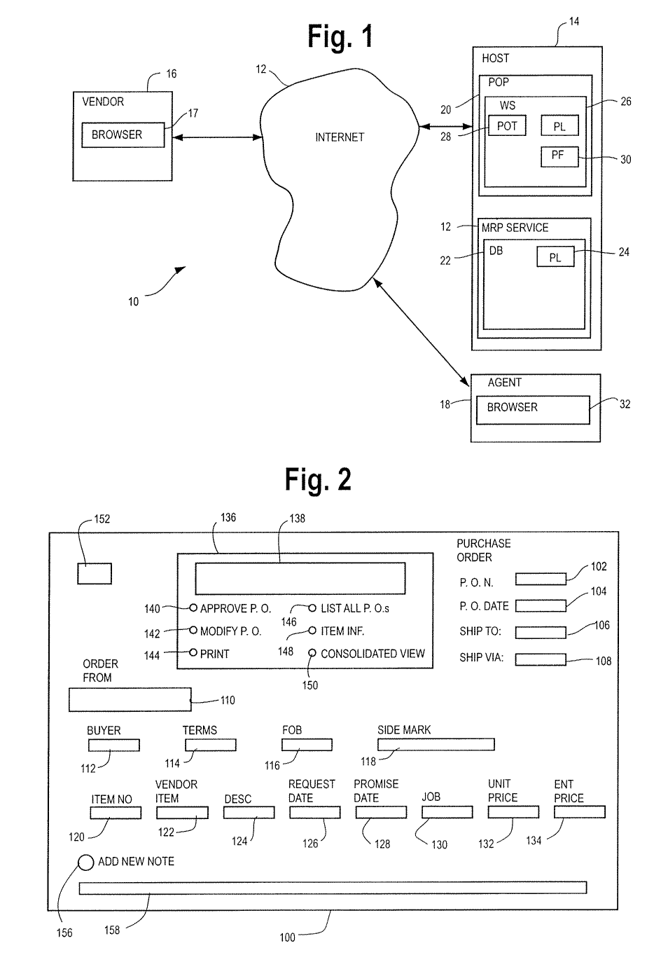

FIG. 1 is a block diagram of a purchase order processing system 10 shown generally in accordance with an illustrated embodiment of the invention. Included within the system 10 may be a host 14 of the purchasing (customer) organization that handles the processing and tracking of purchasing information. Located within the host 14 may be an MRP server 20 operating under control of Manufacturing and Resource Planning (MRP) software provided by an appropriate vendor (e.g., provided by Exact Software, Div. of Exact Holding N.V., located in Delft, The Netherlands). The MRP server 20 functions to track inventories of raw materials and finished product in a SQL database 22 based upon production rates and sales volume.

As part of the tracking process, the MRP server 20 determines inventories of raw materials and compares the determined inventory with a set of trigger points. When the inventory falls below the trigger point, the MRP server 20 add an identifier or description of that inventory item to a Reorder Advice Report (purchase list). A purchase list is used as in indication of an impending shortage of some item and is used by a purchase agent as a basis for purchasing more of that item.

Under an illustrated embodiment of the invention, a purchase order processor or server 20 is provided within the host 14 that may monitor the purchase list of the database 22 of the MRP server 20. Alternatively, the purchase order processor 20 may retrieve the quantities of each raw material, the quantities on order, allocations, safety stock levels, etc. using standard SQL queries and create its own purchase list.

In addition to forming its own purchase list, the purchase order processor 20 may use the information from the purchase lists to automatically create purchase orders in an unreleased form for review and release by customer agents. The automatically created purchase orders may be based upon information from a most recently completed purchase contract.

The purchase order processor 20 may publish the purchase order list through a website 26 of the purchase order processor 20 to authorized customer agents working through one or more terminals 18 for purposes of placing purchase orders. In this regard, authorized customer agents of the organization can log onto the website 26 using a simple browser 32 provided within a respective terminal 18 of the customer agent.

Using the terminal 18 and browser, the customer agent is able to place and negotiate purchase agreements through the website 26 without the need for any other specialized software within the terminal 18. A change tracking subroutine embedded within a purchase order webpage successively exchanged between the customer agent and vendor agent tracks changes between each exchange and sends the changes to a purchase order tracking processor 28 within the purchase order server 20 that saves the details of the negotiations into a purchase file 30 associated with each purchased item. Under one illustrated embodiment, the details of the negotiations may be saved as a series of webpages. Once negotiations are complete, the tracking processor 28 records the final details of the terms of the purchase along with a time of completion and identifiers of the participants into the purchase file 30.

As a first step, the authorized agent of the organization accesses the Internet 12 through a terminal 18 and enters a universal resource locator (URL) of the website 26. In response, the website 26 may download a login webpage containing an interactive window labeled USER NAME and an interactive window labeled PASSWORD. The user may enter his name and password and be granted access to the website 26 with the rights and privileges of a purchase agent.

Once granted access, the customer agent may be presented with a menu webpage. The menu webpage may include a softkey labeled OPEN PURCHASE ORDER.

If the customer agent should activate the OPEN PURCHASE ORDER softkey, the user may be presented with a blank PURCHASE ORDER webpage. Located on the PURCHASE ORDER webpage or on a tool bar may be a softkey labeled PURCHASE LIST. If the user should activate the PURCHASE LIST softkey, the user may be presented with a purchase list of items identified by the MRP server 12 (or by the purchase order processor 20) where the purchase list is based upon inventory levels that have fallen below the inventory trigger points for those items.

The customer agent may select a first item from the purchase list (e.g., labeled “Widget, Part No. XXX”). Where purchase order webpages are automatically prepared in advance, selection of an item from the purchase list may cause the blanks of the purchase order webpage to be automatically filled with the content of the previously prepared purchase order webpage. Alternatively, selection of an item from the purchase list may cause the identifier of the selected item to be entered into an ordered item field only of a purchase order webpage. The remainder of the purchase order webpage may be left blank. Selection of the item may also allow the user to view a product description as well as view a list of vendors that have previously supplied the item and associated purchasing information. For example, one softkey on the webpage may be labeled VIEW ITEM DESCRIPTION. Activation of the VIEW ITEM DESCRIPTION softkey causes the purchase order processor 20 to retrieves a description of the item from the MRP server 12 and display that information as a pop up window on the screen of the terminal 18.

Another softkey on the purchase order webpage may be labeled PREVIOUS PURCHASES. Activation of the PREVIOUS PURCHASES softkey may display a popup screen with a list of most recent previous purchases of the item selected from the purchase list by date of order with the most recent purchase listed first.

The user may select the previous purchases from the list, one at a time, to view the purchase details. Purchase details may include any of a number of purchase order items (e.g., a unit price, delivery time, shipping method, acceptance criteria, etc.).

Under one illustrated embodiment, the user may accept the automatically prepared purchase order or the user can select one of the previous purchases as a template for a current purchase order. The user selects a previous purchase for use as a template by activating a OPEN NEW PURCHASE ORDER softkey while viewing the details of the previous purchase. By activating the OPEN NEW PURCHASE ORDER softkey while viewing the details of the previous purchase, the details of the previous offer may be copied into the fields of the current purchase order webpage 100, including a URL of an agent of the vendor.

Once a purchase order webpage 100 has been populated (either by accepting the automatically prepared purchase order or by activating the OPEN NEW PURCHASE ORDER softkey, the user can modify the purchase order by first activating a MODIFY PURCHASE ORDER softkey 142 on the purchase order webpage 100. By activating the MODIFY ORDER softkey, the user is able to change the terms of the offer. Alternatively, once presented with the purchase order webpage 100, the user can simply begin making changes without the need for a MODIFY ORDER softkey. For example, the user may change a unit price to meet current market conditions. Alternatively, the user may specify a quicker shipping date and increase a unit price to cover the cost of expediting shipment of the item. The customer agent may also activate a ADD NEW NOTE softkey 156 and provide special instructions that are entered through an interactive window 158.

Upon completion of any modifications, the user may activate an ORDER COMPLETE or APPROVE PURCHASE ORDER softkey 140. Activating the APPROVE PURCHASE ORDER softkey causes the purchase order processor 20 to generate a purchase order number and to enter the number into a purchase order field 102 of the purchase order and also a current date. The purchase order processor 20 may also open a new file 30 based upon the purchase order number and save the contents of the revised purchase order (e.g., the purchase order webpage 100) as a first entry in the file 30 along with a time stamp.

Upon completing the purchase order, the customer agent may activate a SEND softkey. Activating the SEND softkey sends a notification message under an appropriate format (e.g., e-mail) to the selected vendor, notifying the vendor of the availability of the purchase order. Included within the message may be a hyperlink to the purchase order webpage 100 within the website 26.

Upon receipt of the notification message through a terminal 16 of the vendor, the vendor agent may retrieve and read the notification message. The agent may also activate the hyperlink within the message. Activation of the hyperlink causes a browser 17 within the terminal 16 of the agent to send a request to the website 26 requesting the purchase order webpage 100.

In response, the website 26 may first send a login webpage to the vendor agent 16. In response, the vendor agent may enter his name into a first interactive windows labeled NAME, his password into a second interactive window labeled PASSWORD and activate a SEND softkey.

Upon receipt of the properly login information, the website 26 downloads the purchase order webpage 100 to the agent 16. Included within the purchase order webpage 100 may be a first field 102 displaying the purchase order of the organization and a second field 103 displaying a purchase order date. A third field 106 may display a shipping address where the ordered item is to be shipped. A fourth field 108 displays the shipping method. A fifth field 110 displays the name and address of the organization and a sixth field 112 may display a name of the buyer or agent of the organization issuing the purchase order.

A number of other fields may display purchase order items within a number of interactive windows 114, 116, 118, 120, 122, 124, 126, 128, 130, 132, 134. Initially shown within the windows 114, 116, 118, 120, 122, 124, 126, 128, 130, 132, 134 are purchase order items proposed by the agent of the organization. The agent of the vendor may change one or more of the purchase order items or accept the purchase order without substantive change. If the agent for the vendor accepts the purchase order without changes, then the purchase order may be sent back to the customer agent for approval and confirmed. If the terms of the purchase order are modified, then the vendor modified purchase order webpage 100 is returned to the customer agent who can then accept the changes or the customer agent may make further changes. If the customer agent makes further changes, then the customer modified purchase order webpage 100 is returned to the vendor agent for further consideration. The sequential presentation of the purchase order webpage 100, first to the vendor agent and then to the customer agent defines a negotiation between the customer and vendor through their respective agents.

Turning now to the purchase order webpage 100 of FIG. 2, in specific, a control panel or dashboard 136 may be provided for controlling the interaction provided through use of the webpage 100. Also included within the data file that defines the webpage 100 is a program (e.g., a change tracking subroutine) 152 that provides the functionality of the webpage 100 under control of the control panel 136.

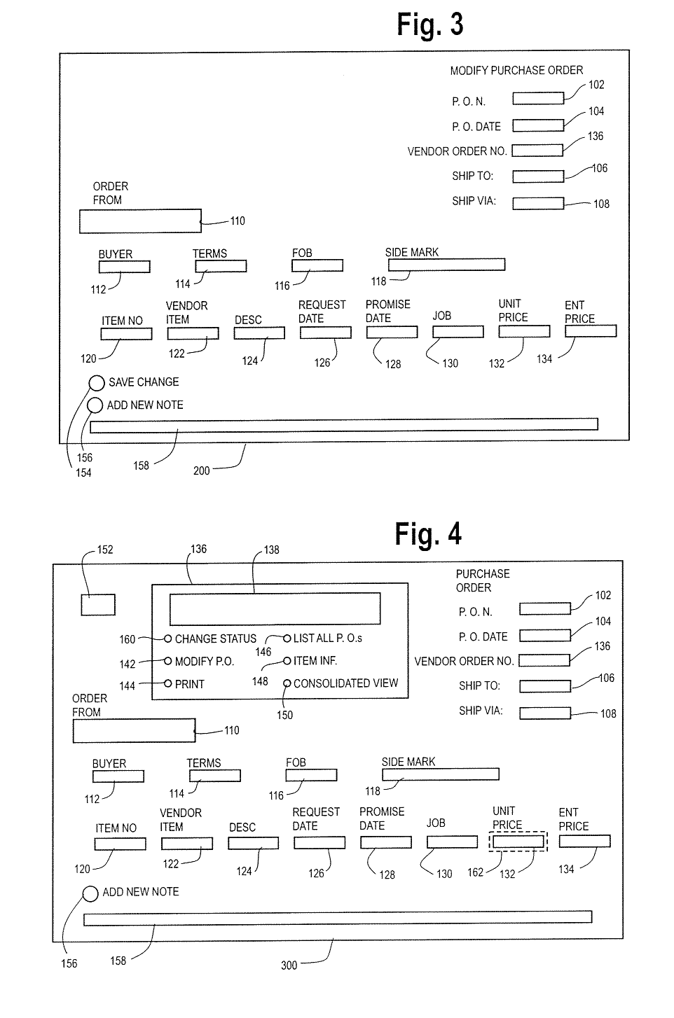

For example, even if the vendor agent should choose to accept the order terms of the purchase order webpage 100 of FIG. 2 as initially presented, the vendor agent may still need to enter a vendor order number in an interactive window 136 and/or a ship date in a promise date window 128. In this case, the vendor agent may activate the MODIFY PURCHASE ORDER softkey 142. In response, the webpage 200 of FIG. 3 is displayed for the benefit of the vendor agent.

On the webpage 200, the vendor agent enters a vendor order number in an interactive window 136 and a ship date in the promise date window 128. The agent for the vendor may then activate the SAVE CHANGE softkey to return to the purchase order webpage 100. The vendor agent 16 may then activate the APPROVE PURCHASE ORDER softkey 140 to send the modified purchase order webpage 100 back to the customer vendor.

Alternatively, the agent for the vendor may find the purchase order unacceptable for some reason. As above, the agent for the vendor would activate the MODIFY softkey 142 to be taken to the webpage 200. On the webpage 200, the agent of the vendor may select a order term 114, 116, 118, 120, 122, 124, 126, 128, 130, 132, 134 and enter any changes. For example, if the agent for the vendor should find that the unit price in the unit price window 132 is too low, then the agent may enter a different price based upon the vendor's current profit structure or a discounted price based upon a determined need to do business with the organization. Alternatively, the agent may change the promise date entered within a promise date window 128, or enter a different free-on-board (FOB) location within window 116. Once the needed changes have been made, the agent for the vendor may again activate the SAVE CHANGE softkey 154.

The agent for the vendor may also activate the ADD NEW NOTE softkey 156. After activating the softkey 156, the user can enter text (i.e., the reason for the change in the text box 158) under the vendor agent's name and activate the SAVE CHANGE softkey 154.

Upon activating the SAVE CHANGE softkey 154 and APPROVE PURCHASE ORDER softkey 140, any changes entered by the vendor agent are incorporated by the program 152 into a webpage message that is sent back to the purchase order processor 20 through the Internet 12 and website 26. Upon receipt, the message (or the entire modified purchase order webpage 100) is saved in the purchase order file 30 associated with the purchase order number along with a time stamp. The webpage message from the vendor agent may be saved as a second entry of a chronological list of changes within the file 30 capturing the purchase order term changes during this step of the negotiation.

When the agent 18 again signs into the website 26, the agent 18 is presented with a selection menu that includes a PURCHASE ORDERS WAITING ON CUSTOMER softkey. Upon activating the PURCHASE ORDERS WAITING ON CUSTOMER softkey, the customer agent 18 is presented with a list of purchase orders from vendors. In this case, each of the purchase orders from vendors are the modified purchase order webpages 100 returned from respective vendor agents during some step of a negotiation. Upon selection of one of the purchase orders, the agent 18 may be presented with the vendor revised purchase order webpage 100 (now relabeled 300 of FIG. 4).

The webpage 300 of FIG. 4 may be substantially the same as the webpage 100 of FIG. 2 previously sent by the customer agent 18 to the vendor agent 16 except as noted below. For example, any note added in window 158 under the name of the vendor agent is displayed above any previous note from the customer agent in reverse chronological order. In addition, any changes to the order terms made by the vendor agent are highlighted. For example, as shown on webpage 300, if the unit price in window 132 had been changed by the agent 16, then highlighting 162 appears around the window 132 to indicate that the purchase order term has been changed. Another difference between the webpage 100 and 300 is that instead of having a APPROVE softkey 140, the webpage 300 has a CHANGE STATUS softkey 160. Another difference is that when the agent 18 places his cursor over a highlighted window 132, the original order term is temporarily displayed in a new box adjacent the changed term. When the cursor is moved away from the highlighted box, the new box (and originally entered order term) disappears.

The agent 18 can now review the revised purchase order webpage 300 paying special attention to the highlighted order terms. If the agent 18 is satisfied with the new order terms, then the agent 18 selects the CHANGE STATUS softkey 160.

Upon activation of the CHANGE STATUS softkey 160, the agent 18 may be presented with a list of vendors (or only the vendor associated with the webpage 300). The agent 18 selects the vendor and purchase order number 102 (if more than one purchase order is pending with the vendor). In response, the agent 18 is presented with a PURCHASE ORDER APPROVE softkey. The agent 18 activates the softkey to approve the purchase order.

Upon approval of the purchase order, the purchase order processor 20 presents the agent 18 with a confirmation box that is used to send a confirming message approving the purchase order to the vendor. The agent 18 may enter a message and activate a SEND softkey to send the confirming message to the vendor agent 16.

Upon activating the SEND softkey, the purchase order processor 20 also saves the order terms (or a copy of the purchase order webpage 300) in the purchase order file 30 along with the approved status of purchase order.

If the agent 18 is not satisfied with at least some of the order terms, the agent 18 may activate the MODIFY PURCHASE ORDER softkey 142 on the webpage 300. In response, the agent 18 is presented with a webpage similar to the webpage 200. One important difference is that the order terms shown in windows 114, 116, 118, 120, 122, 124, 126, 128, 130, 132, 134 include the changes entered by the vendor 16 from the previous step of the negotiation. The customer agent 18 can select each of the windows 114, 116, 118, 120, 122, 124, 126, 128, 130, 132, 134, in turn, and make further changes. The customer agent 18 can even change order terms back to original values.

The customer agent 18 may activate the ADD NEW NOTE softkey at the bottom to add text explaining why the proposal from the vendor agent 16 was not acceptable. Upon completion of entry of the message, the customer agent may activate the SAVE CHANGE softkey.

Upon activation of the SAVE CHANGE softkey, the purchase order processor 20 saves the changes made by the customer agent 18 to the new customer proposed purchase order webpage 100 and saves the changes (or modified purchase order webpage 300) as a new entry within the purchase order file 30. The purchase order processor 20 also composes and sends a message to the vendor agent 16, notifying the vendor agent 16 of the availability of the revised purchase order (new purchase order webpage 100). The vendor agent 16 may retrieve the revised purchase order and the process may repeat.

If the vendor agent 16 should open the new webpage 100 and agree with the revisions, then the vendor agent 16 may activate the APPROVE PURCHASE ORDER softkey 140. The vendor agent 16 may activate the NEW NOTE softkey 156 and enter a message through the window 158 to the customer agent. Finally, the vendor agent 16 may activate the SAVE CHANGE softkey 154 and APPROVE PURCHASE ORDER softkey 140.

Upon completion of his/her response, the vendor agent can also perform other activities based upon his/her current access to the website 26. For example, after reviewing a proposed purchase order webpage, the vendor agent may activate a PRINT softkey 144 to print a copy of purchase order webpage 100 for the vendor agent's records.

Alternatively, the vendor agent may wish to view other purchase orders under negotiation. In this case, the vendor agent may activate a LIST ALL PURCHASE ORDERS softkey 148 to view any other pending purchase order.

On the other hand, the vendor agent may be unsure of the subject matter of a purchase order webpage 100. In this case, the vendor agent 16 may activate an ITEM INFORMATION softkey 148. In this case, the purchase order processor 20 may retrieve an item specification and description from the SQL database 22 and display the item information in a pop up window on a display of the vendor terminal 16.

By tracking each exchange between a customer agent and vendor agent, the customer organization creates a written history of each purchasing transaction that can be maintained for an extended period of time. The inclusion of each purchase order term within the record at each step of the negotiation allows disputes to be resolved based upon factual information rather than upon the incomplete memories of purchase agents who are often overworked and have little time to devote to record keeping.

For example, if a dispute arose, a supervisor may access the purchase order file 30 through the terminal 18 and print a purchase order history. In this case, the purchase order history may include a printout of a first purchase order webpage 100 sent from the customer agent to the vendor agent and a response purchase order webpage 100 returned to the customer agent. The printout may also include any purchase order webpages 100 thereafter in sequential order along with a timestamp associated with each webpage, ending with the approval from the customer agent. Alternatively, if the negotiation were not successful, then the file 30 would include any purchase order webpage 100 transferred between the parties until the point of termination of negotiation.

A specific embodiment of method and apparatus for processing orders has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of processing orders by a host of an ordering customer organization, the orders being placed by the ordering organization with a vendor, such method comprising:
an agent of the ordering organization accessing an order website and entering a plurality of order items;
the host incorporating the order items and a change subroutine into a webpage;
an agent of the vendor retrieving the webpage from the host of the ordering organization;
the agent of the ordering organization and agent of the vendor negotiating the conditions of the order via changes to the webpage; and
the change subroutine tracking and recording the changes to the webpage.

2. The method of processing orders as in claim 1 wherein the step of negotiating further comprises the customer agent and vendor agent exchanging a successively modified webpage.

3. The method of processing orders as in claim 2 wherein the step of exchanging successively modified webpage further comprises saving the successively modified webpages along with a respective time stamp in a purchase order file.

4. The method of processing orders as in claim 1 further comprising displaying at least some of the order items on the webpage within a respective set of interactive windows.

5. The method of processing orders as in claim 4 wherein the respective set of interactive windows further comprise at least some of the group consisting of an order item identifier, a price, a delivery date and a delivery method.

6. The method of processing orders as in claim 1 further comprising the change subroutine providing a control panel for entering proposed changes to the order.

7. The method of processing orders as in claim 1 further comprising providing an order approval softkey for acceptance of the order by the agent of the vendor or the agent of the ordering organization.

8. The method of processing orders as in claim 1 further comprising one of the agent of the ordering organization and agent of the vendor selecting an order item and changing the order item.

9. The method of processing orders as in claim 8 further comprising the host notifying the other of the agent of the ordering organization and agent of the vendor of the changed order item.

10. An apparatus for processing orders by a host of an ordering customer organization, the orders being placed by the ordering organization with a vendor, such apparatus comprising:
means used by an agent of the ordering organization for accessing an order website and entering a plurality of order items;
means within the host for incorporating the order items into a webpage;
means used by an agent of the vendor for retrieving the webpage from the host of the ordering organization;
means used by the agent of the ordering organization and agent of the vendor for negotiating the conditions of the order via changes to the webpage; and
means for tracking and recording the changes to the webpage.

11. The apparatus for processing orders as in claim 10 wherein the step of negotiating further comprises means used by the customer agent and vendor agent for exchanging a successively modified webpage.

12. The apparatus for processing orders as in claim 11 wherein the means for exchanging successively modified webpage further comprises means for saving the successively modified webpage in a purchase order file.

13. The apparatus for processing orders as in claim 10 further comprising means for displaying at least some of the order items on the webpage within a respective set of interactive windows.

14. The apparatus for processing orders as in claim 13 wherein the respective set of interactive windows further comprise at least some of the group consisting of an order item identifier, a price, a delivery date and a delivery method.

15. The apparatus for processing orders as in claim 10 wherein the means for negotiating the order further comprises means for entering proposed changes to the order.

16. The apparatus for processing orders as in claim 10 further comprising means for accepting the purchase order by the agent of the vendor or the agent of the ordering organization.

17. The apparatus for processing orders as in claim 10 further comprising means used by one of the agent of the ordering organization and agent of the vendor for selecting an order item and changing the order item.

18. The apparatus for processing orders as in claim 17 further comprising means within the host for notifying the other of the agent of the ordering organization and agent of the vendor of the changed order item.

19. An apparatus for processing orders by a host of an ordering customer organization, the orders being placed by the ordering organization with a vendor, such apparatus comprising:
the host accessible by an agent of the ordering organization used by the agent for entering a plurality of purchase order items;
a webpage that incorporates the order items;
a message sent to an agent of the vendor that retrieves the webpage from the host of the ordering organization;
a website used by the agent of the ordering organization and agent of the vendor that exchanges negotiated conditions of the order via changes to the webpage; and
a memory for tracking and recording the changes to the webpage.

20. The apparatus for processing orders as in claim 19 wherein the negotiated conditions further comprises a successively modified webpage exchanged between the customer agent and vendor agent.

21. The apparatus for processing orders as in claim 20 further comprising a purchase order file that saves the successively modified webpage.

22. The apparatus for processing orders as in claim 19 further comprising a set of interactive windows that display at least some of the order items on the webpage.

23. The apparatus for processing orders as in claim 22 wherein the respective set of interactive windows further comprise at least some of the group consisting of an order item identifier, a price, a delivery date and a delivery method.
